(19) United States
(12) Patent Application Publication
(10) Pub. No.: US 2008/0037122 A1
(43) Pub. Date: Feb. 14, 2008

(54) Reflective type polarizing diffusive film and method of manufacturing the same

(75) Inventors: Yun-Pin Yang, Taoyuan (TW); Chi-Wen Liao, Taoyuan (TW); Chi-Liang Tseng, Taoyuan (TW)

Correspondence Address: TROXELL LAW OFFICE PLLC, 5205 LEESBURG PIKE, SUITE 1404, FALLS CHURCH, VA, 22041, US

(73) Assignee: Exploit Technology Co., Ltd.

(21) Appl. No.: 11/502,507

(22) Filed: Aug. 11, 2006

(51) Int. Cl. G02B 27/28

(52) U.S. Cl. 359/485

(57) ABSTRACT

In a method of manufacturing a reflective type polarizing diffusive film, a shielding reflection layer is formed on one surface of a substrate, a plurality of grooves are then formed on the shielding reflection layer, and finally, a diffusive layer is formed on the shielding reflection layer. Each of the grooves penetrates into the substrate for light to pass therethrough. Due to the grooves on the shielding reflection layer and the electromagnetic wave, light vibrating in a direction normal to an axis of the shielding reflection layer is blocked by a reverse electric field induced by the shielding reflection layer, and light vibrating in a direction parallel to the axis of the shielding reflection layer is allowed to pass through the shielding reflection layer to produce polarized light. The blocked light is reflected by the shielding reflection layer to the original optical path for reuse, so as to provide largely enhanced brightness.

### FIELD OF THE INVENTION

The present invention relates to a polarizing diffusive film, and more particularly to a reflective type polarizing diffusive film providing large viewing angle and good spot luminance distribution. The present invention also relates to a method of manufacturing a reflective type polarizing diffusive film.

### BACKGROUND OF THE INVENTION

In a conventional way of manufacturing a polarizer, a transparent substrate made of a polyvinyl alcohol (PVA) material is immerged in a water solution of iodine (I₂) or potassium iodide (KI), so that Iodide ions permeate into the PVA substrate. The substrate is then stretched, and the iodide ions attached to the PVA substrate become orientated to form a long chain of iodide ions. The iodide ion has very good polarizing ability to absorb light beam field component that is parallel to the direction of arrangement of the iodide ions, so that only the light beam field component normal to the iodide ion arrangement direction is allowed to pass through the substrate. By employing this principle, a polarizing film may be manufactured. However, with the polarizing film manufactured by employing the light absorption property of the iodide ion, light vibrating along an axis normal to the stretching direction is absorbed and could not return to the original optical path and be utilized again, resulting in largely attenuated brightness.

In a prior art reflective type polarizing diffusive film, namely, the DBEF-D supplied by 3M, about a thousand layers of birefringence polymer films are laminated to produce bending of light, so that polarized light along one axis is allowed to pass through the diffusive film while polarized light along another axis is refracted to the original optical path and recovered for use. Since about a thousand of layers of films are needed to manufacture this type of diffusive film, the manufacturing process is complicate and very expensive.

### SUMMARY OF THE INVENTION

A primary object of the present invention is to provide a reflective type polarizing diffusive film, in which a grooved shielding reflection layer and the property of electromagnetic wave are utilized, so that light vibrating in a direction normal to the axis of the shielding reflection layer is blocked by a reverse electric field induced by the shielding reflection layer containing high reflectance polymers, and only the light vibrating in a direction parallel to the axis of the shielding reflection layer is allowed to pass through the reflection layer to produce polarized light.

Another object of the present invention is to provide a reflective type polarizing diffusive film, in which the reflection produced by a shielding reflection layer is utilized to reflect the blocked light to the original optical path for reuse, so as to provide largely enhanced brightness.

A further object of the present invention is to provide a method for manufacturing a reflective type polarizing diffusive film.

To achieve the above and other objects, the reflective type polarizing diffusive film according to the present invention includes a substrate, a high reflectance polymeric shielding reflection layer formed on one side of the substrate, and a diffusive layer formed on the shielding reflection layer. The shielding reflection layer is formed with a plurality of nano-sized grooves, which have a depth sufficient for penetrating into the substrate for light to pass therethrough.

The reflective type polarizing diffusive film according to the present invention is manufactured by doping a high reflectance compound nano powder in a polymer to form a high reflectance polymer; coating the high reflectance polymer on one side of a substrate to form a shielding reflection layer; forming a plurality of grooves on the shielding reflection layer using a die; and forming a diffusive layer on the shielding reflection layer. The die has a nano structure provided thereon by way of etching or laser, and the grooves are formed on the shielding reflection layer using the die by way of rolling or punching. The shielding reflection layer is then cured by exposing it to ultraviolet. And, the diffusive layer is coated on the shielding reflection layer and then cured by baking at high temperature.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual perspective view of a reflective type polarizing diffusing film according to the present invention;

FIG. 2 is an enlarged view of the area indicated by phantom line 2 in FIG. 1; and

FIG. 3 is an enlarged view of the area indicated by phantom line 3 in FIG. 1.

### DETAILED DESCRIPTION OF THE PREFERRED EMBODIMENTS

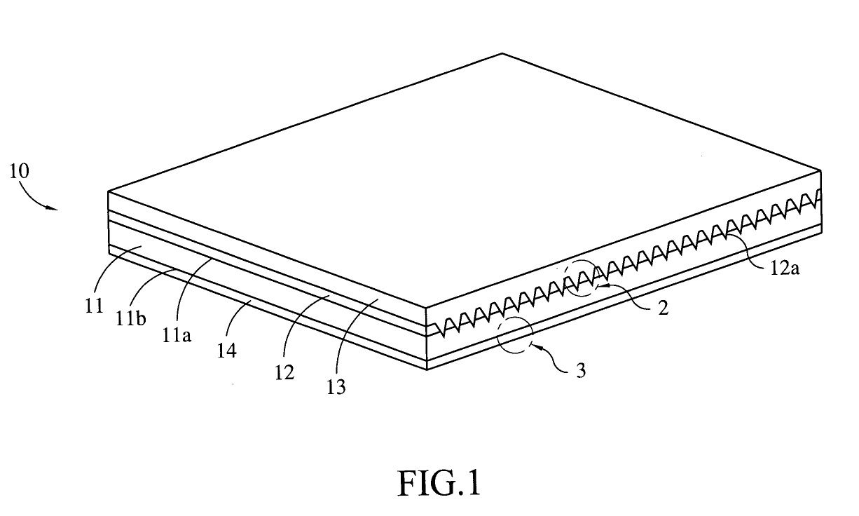

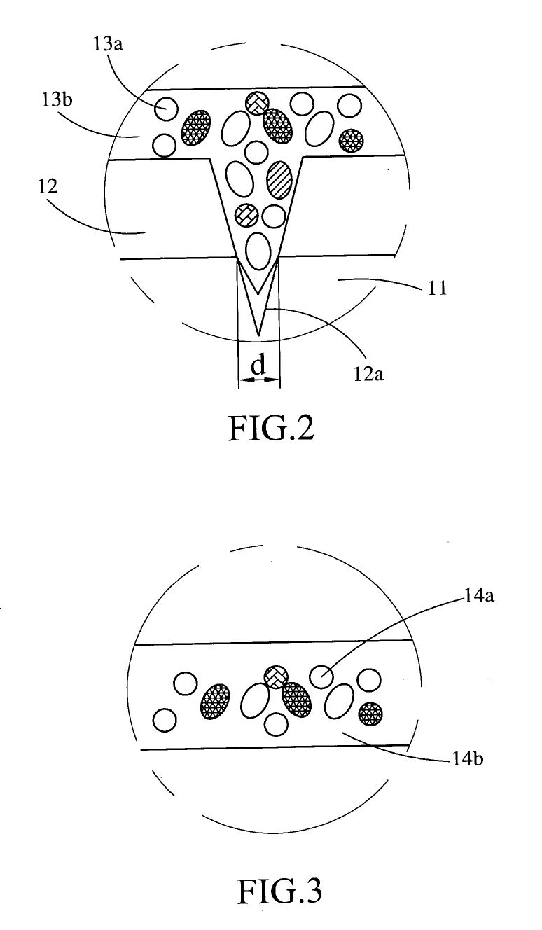

Please refer to FIG. 1 that is a conceptual perspective view of a reflective type polarizing diffusive film 10 according to the present invention, and to FIGS. 2 and 3 that are enlarged views of the areas indicated by phantom lines 2 and 3 in FIG. 1, respectively. As shown, the reflective type polarizing diffusive film 10 includes a light-transmittable substrate 11 having an tipper surface 11a and a lower surface 11b; a high reflectance polymeric shielding reflection layer 12 is formed on the upper surface 11a of the substrate 11 by way of coating; a first diffusive layer 13 formed on the high reflectance polymeric shielding reflection layer 12; and a second diffusive layer 14 formed on the lower surface 11b of the substrate 11.

On the shielding reflection layer 12, a plurality of grooves 12a are formed using a nano-micro structured die (not shown).

Each of the grooves 12a preferably has a depth large enough to penetrate into the substrate 11, so as to form a light-transmittable gap d on the upper surface 11a of the substrate below the groove 12a.

The first diffusive layer 13 consists of a plurality of particles 13a and an optical material 13b; and the second diffusive layer 14 consists of a plurality of particles 14a and an optical material 14b. Wherein, the optical materials 13b, 14b may be an optical plastic material, such as polystyrene, polymethyl methacrylate, polycarbonate, polyvinyl, polypropylene, polyvinyl chloride, epoxy resin, polyethylene terephthalate, and polylactic resin. The reflective type polarizing diffusive film 10 is not necessarily limited to have a specific side as an incident face. Both sides of the diffusive film 10 may serve as the incident face. When lights pass the gap d, only the lights vibrating in a direction parallel to the gap d are allowed to pass through the diffusive film 10, while the lights vibrating in a direction normal to or non-parallel to the gap d, due to an electric field induction of the high reflectance polymeric shielding reflection layer 12, are reflected to the original optical path and reused. A method of manufacturing the reflective type polarizing diffusive film 10 according to the present invention includes the steps of:
(1) Preparing a polymer coating by evenly doping one or more types of high reflectance compound nano powder, such as aluminum, aluminum compounds, zinc, zinc compounds, titanium, titanium compounds, and high dielectric ceramics powder, in a photo-initiator added UV-curable polymer, such as different optical plastic materials, including polystyrene, polymethyl methacrylate, polycarbonate, polyvinyl, polypropylene, polyvinyl chloride, epoxy resin, and polyethylene terephthalate.

Preferably, the high reflectance compound nano powder has a size within the range from 200 μm to 20 nm. The high reflectance compound nano powder having a bar shape instead of a ball shape is preferably selected because the bar-shaped powder has a dielectric constant higher than that of the ball-shaped powder. Further, the nano powder of a high reflectance compound having a dielectric constant higher than 10 is preferably selected for use. According to the dielectric constant ε of a selected compound, the reflectance r of a polymeric shielding reflection layer and the percentage by volume v (%) of the high reflectance compound nano powder relative to the UV-curable polymer may be defined using the following formulas:

$$\begin{matrix}r = \frac{\sqrt{{ɛ}_{r}} - 1}{\sqrt{{ɛ}_{r}} + 1} & ( 1 ) \\ v ( \% ) = \frac{( \sqrt{{ɛ}_{r}} - \sqrt{{ɛ}_{m}} )}{( \sqrt{{ɛ}_{1}} - \sqrt{{ɛ}_{m}} ) + ( \sqrt{{ɛ}_{2}} - \sqrt{{ɛ}_{m}} ) + … + ( \sqrt{{ɛ}_{i}} - \sqrt{{ɛ}_{m}} )} & ( 2 )\end{matrix}$$

where,
in the formula (1):
   εᵣ is the dielectric constant of the polymeric shielding reflection layer;
and in the formula (2):
   ε_{m i}s the dielectric constant of the UV-curable polymer;
   ε₁ is the dielectric constant of a first type high reflectance compound nano powder;
   ε₂ is the dielectric constant of a second type high reflectance compound nano powder; and
   εᵢ is the dielectric constant of an i^{th} type high reflectance compound nano powder.
(2) Coating the polymer prepared in step (1) on the upper surface 11a of the substrate 11 preferably by a film coating technique to form a film of uncured polymeric shielding reflection layer 12.
(3) Preparing a nano-micro structured die, and forming a nano structure on the surface of the die by way of etching or laser; pressing the die against the shielding reflection layer 12 to form a plurality of nano-sized grooves 12a on the shielding reflection layer 12. Preferably, the grooves 12a are formed on the uncured polymeric shielding reflection layer 12 by way of rolling or punching. And, the grooves 12a preferably have a depth sufficient for penetrating into the substrate 11 to form a plurality of light-transmittable gaps d on the surface of the substrate 11.
(4) Curing the shielding reflection layer 12 by irradiating the shielding reflection layer 12 with a UV lamp, so that the grooves 12a are cured to facilitate processing in the next procedure.
(5) Preparing a suitable diffusive material, and coating the prepared diffusive material on the shielding reflection layer 12 and on the lower surface 11b of the substrate 11 to form a diffusive layer 13, 14 on each side of the substrate 11; and curing the resultant diffusive layers by baking them at a proper temperature to complete the reflective type polarizing diffusive film 10.

The diffusive layer 13 consists of a plurality of particles 13a and an optical material 13b; and the diffusive layer 14 consists of a plurality of particles 14a and an optical material 14b. Wherein, the optical materials 13b, 14b may be an optical plastic material, such as polystyrene, polymethyl methacrylate, polycarbonate, polyvinyl, polypropylene, polyvinyl chloride, epoxy resin, polyethylene terephthalate, and polylactic resin.

In brief, in the present invention, grooves formed on a shielding reflection layer and the property of electromagnetic wave are employed to polarize light passing through the reflective polarization diffusive film of the present invention, and the shielding reflection layer is used to reflect the blocked light to an original optical path for reuse and thereby provides largely enhanced brightness.

What is claimed is:

1. A method of manufacturing a reflective type polarizing diffusive film, comprising the steps of:
doping a compound nano powder in an ultraviolet (UV) curable polymer to form a high reflectance polymer;
coating said high reflectance polymer on one side of a substrate to form a shielding reflection layer;
forming a plurality of grooves on said shielding reflection layer; and
forming a diffusive layer on said shielding reflection layer.

2. The method of manufacturing a reflective type polarizing diffusive film as claimed in claim 1, wherein said grooves are formed by rolling or punching using a die.

3. The method of manufacturing a reflective type polarizing diffusive film as claimed in claim 2, wherein said shielding reflection layer is cured after said a plurality of grooves are formed.

4. The method of manufacturing a reflective type polarizing diffusive film as claimed in claim 1, wherein said diffusive layer is cured by baking said diffusive layer at a high temperature.

5. The method of manufacturing a reflective type polarizing diffusive film as claimed in claim 1, wherein said compound nano powder is selected from a material having a dielectric constant E higher than 10, and wherein said shielding reflection layer has a reflectance r defined by the following formula (1):
$$r = \frac{\sqrt{{ɛ}_{r}} - 1}{\sqrt{{ɛ}_{r}} + 1} \qquad ( 1 )$$
and wherein a percentage by volume v (%) of said high reflectance compound nano powder relative to said UV-curable polymer is defined by the following formula (2):
$$v ( \% ) = \frac{( \sqrt{{ɛ}_{r}} - \sqrt{{ɛ}_{m}} )}{( \sqrt{{ɛ}_{1}} - \sqrt{{ɛ}_{m}} ) + ( \sqrt{{ɛ}_{2}} - \sqrt{{ɛ}_{m}} ) + … + ( \sqrt{{ɛ}_{i}} - \sqrt{{ɛ}_{m}} )} \qquad ( 2 )$$
where,
in the formula (1):
εᵣ is the dielectric constant of the polymeric shielding reflection layer;
and in the formula (2):
εₘ is the dielectric constant of the UV-curable polymer;
ε₁ is the dielectric constant of a first type high reflectance compound nano powder;
ε₂ is the dielectric constant of a second type high reflectance compound nano powder; and
εᵢ is the dielectric constant of an i^{th} type high reflectance compound nano powder.

6. A reflective type polarizing diffusive film, comprising:
a substrate having an upper and a lower surface;
a shielding reflection layer formed on said upper surface of said substrate and having a plurality of grooves formed thereon; and
a diffusive layer formed on said shielding reflection layer.

7. The reflective type polarizing diffusive film as claimed in claim 6, wherein said grooves are formed using a die having a nano-micro structure provided thereon.

8. The reflective type polarizing diffusive film as claimed in claim 7, wherein each of said grooves has a depth sufficient for penetrating into said upper surface of said substrate to form a light-transmittable gap on the upper surface of said substrate.

9. The reflective type polarizing diffusive film as claimed in claim 6, wherein said substrate is formed on said lower surface with another said diffusive layer.

10. The reflective type polarizing diffusive film as claimed in claim 6, wherein said diffusive layer consists of a plurality of particles and an optical material; and said optical material being an optical plastic material selected from the group consisting of polystyrene, polymethyl methacrylate, polycarbonate, polyvinyl, polypropylene, polyvinyl chloride, epoxy resin, polyethylene terephthalate, and polylactic resin.

11. The reflective type polarizing diffusive film as claimed in claim 8, wherein said gap allows light vibrating in a direction parallel to said gap to pass therethrough, while light vibrating in a direction normal to or non-parallel to said gap, due to an electric field induction of said shielding reflection layer, is reflected to an original optical path.
